(19) United States
(12) Patent Application Publication
(10) Pub. No.: US 2026/0295818 A1
(43) Pub. Date: Oct. 1, 2026

(54) System and method suitable for training an agent using a risk-adaptive distributional reinforcement learning framework

(71) Applicant: Mitsubishi Electric Research Laboratories, Inc., Cambridge, MA (US)

(72) Inventors: Radu Ioan Corcodel, Brookline, MA (US); Yuyou Zhang, Pittsburgh, PA (US)

(73) Assignee: Mitsubishi Electric Research Laboratories, Inc., Cambridge, MA (US)

(21) Appl. No.: 19/090,038

(22) Filed: Mar. 25, 2025

(51) Int. Cl. B25J 9/16; G06N 3/092

(52) U.S. Cl. CPC B25J 9/163; G06N 3/092

(57) ABSTRACT

The present disclosure provides a system and a method for training an agent to perform a task in a dynamic environment. The method includes determining a return distribution representing probabilistic outcomes of actions of the agent in the dynamic environment, wherein the return distribution captures variability in cumulative rewards of the training. The method further includes applying a distortion function to the return distribution to distort the return distribution based on varying risk preferences defined by at least one parameter of the distortion function. The method further includes dynamically adjusting the at least one parameter of the distortion function during the training based on a measure of uncertainty derived from the return distribution. The method further includes training the agent by iteratively updating its policy based on the distorted return distribution.

### TECHNICAL FIELD

The present disclosure relates generally to machine learning, and more specifically to a system and a method for training an agent a risk-adaptive distributional reinforcement learning framework.

### BACKGROUND

Reinforcement learning (RL) is a field of machine learning that offers a framework for training an agent to solve complex decision-making problems or perform a task. In RL, the agent learns by interacting with an environment, aiming to maximize cumulative rewards over time. The RL optimizes policies based on an expected return—a single scalar value that represents an average outcome of the agent's actions. While this RL method has been successfully applied to various domains, it exhibits several limitations when deployed in practical, dynamic environments.

Real-world applications involve significant variability and uncertainty, where the same action may lead to vastly different outcomes depending on external factors or stochastic dynamics. The RL methods struggle to capture this variability, as they rely solely on the expected return. The reliance only on the expected return can result in the policies that fail to account the variability, leading to suboptimal behavior in the dynamic environments.

Accordingly, there is a need for further advancements in RL frameworks for training the agent to perform the task in the dynamic environment.

### SUMMARY

It is an objective of some embodiments to adapt reinforcement learning (RL) for applications in dynamic and uncertain environments. The RL is a machine learning methodology where an agent learns to make decisions by interacting with the dynamic environment. Through iterative exploration and feedback, the agent refines its actions to optimize a cumulative reward. In each iteration, the agent updates its policy based on a reward obtained in that iteration.

The RL aims to maximize an expected return, which represents an average reward over all possible actions. However, such RL approach is well-suited to structured environments but may encounter limitations in the dynamic environment where variability and uncertainty are significant factors.

To overcome such limitations, some embodiments of the present disclosure use distributional RL which models a return distribution representing probabilistic outcomes of actions of the agent in the dynamic environment. However, distributional RL generally rely on static configurations, which may limit their applicability in scenarios requiring adaptability to evolving environmental or task conditions.

Some embodiments of the present disclosure introduce a risk-adaptive distributional RL framework that incorporates dynamic risk adaptation within a distributional RL context. This framework provides an additional degree of freedom by allowing dynamic adjustment of how the return distribution is utilized during training of the agent. By weighting different regions of the return distribution, the risk-adaptive distributional RL framework enables the policies to reflect specific nature of the dynamic environment, or the task being performed. For example, in the uncertain environments, the risk-adaptive distributional RL framework prioritizes actions aligned with stability and caution, whereas, in more predictable or exploratory environments, the risk-adaptive distributional RL framework emphasizes actions that pursue greater rewards. This adaptability ensures that the risk-adaptive distributional RL framework is responsive to a wide range of operating conditions.

The weighting of different regions of the distribution is adjusted by dynamically modifying parameters of a distortion function based on variability of the dynamic environment captured in the return distribution. In some implementations, the variability is quantified using metrics, such as a coefficient of variation of the return distribution. By leveraging these metrics, the risk-adaptive distributional RL framework can continuously adapt to environmental changes and task complexities. For instance, in a robotic application, the risk-adaptive distributional RL framework may adjust policies to accommodate transitions between tasks, such as moving from a stable locomotion task to one involving precise manipulation. Such a dynamic adaptation reduces likelihood of inefficiencies or failures in training, thereby enhancing reliability and practicality of training of the agent.

By incorporating mechanisms to dynamically adjust how the variability in the return distribution is handled, the embodiments of the present disclosure ensure robust and efficient performance in the dynamic and the uncertain environments. Further, the risk-adaptive distributional RL framework addresses long standing limitations of static RL methods, enabling development of training methods and control systems that are better suited to meet demands of complex, real-world applications.

Accordingly, one embodiment discloses a method for training an agent to perform a task in a dynamic environment. The method uses a processor coupled with stored instructions implementing the method, wherein the instructions, when executed by the processor carry out steps of the method, comprising: determining a return distribution representing probabilistic outcomes of actions of the agent in the dynamic environment, wherein the return distribution captures variability in cumulative rewards of the training; applying a distortion function to the return distribution to distort the return distribution based on varying risk preferences defined by at least one parameter of the distortion function; dynamically adjusting the at least one parameter of the distortion function during the training based on a measure of uncertainty derived from the return distribution; and training the agent by iteratively updating its policy based on the distorted return distribution.

Accordingly, another embodiment discloses a system for training an agent to perform a task in a dynamic environment. The system comprises: a processor; and a memory having instructions stored thereon that, when executed by the processor, cause the system to: determine a return distribution representing probabilistic outcomes of actions of the agent in the dynamic environment, wherein the return distribution captures variability in cumulative rewards of the training; apply a distortion function to the return distribution to distort the return distribution based on varying risk preferences defined by at least one parameter of the distortion function; dynamically adjust the at least one parameter of the distortion function during the training based on a measure of uncertainty derived from the return distribution; and train the agent by iteratively updating its policy based on the distorted return distribution.

Accordingly, yet another embodiment discloses a control system for controlling a robot to execute a task in a dynamic environment, comprising: a memory configured to store a control policy of the robot for controlling the robot to execute the task; and a processor communicatively coupled to the memory and configured to: determine a return distribution representing probabilistic outcomes of actions of the robot in the dynamic environment; compute a measure of variability in the return distribution; adjust a risk adjustment parameter of a distortion function based on the measure variability in the return distribution; distort the return distribution based on the distortion function with the adjusted risk adjustment parameter; based on the distorted return distribution, update the control policy of the robot; and execute at least action of the robot based on the updated control policy, to execute the task in the dynamic environment.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1A illustrates a block diagram of a method for training an agent to perform a task in a dynamic environment, according to an embodiment of the present disclosure.

FIG. 1B illustrates an example return distribution, according to an embodiment of the present disclosure.

FIG. 1C illustrates distorted return distributions, according to an embodiment of the present disclosure.

FIG. 2 shows a system for training the agent to perform the task, according to some embodiments of the present disclosure.

FIG. 3A illustrates dynamically adjusting a risk adjustment parameter of a distortion function during the training, according to some embodiments of the present disclosure.

FIG. 3B illustrates dynamically adjusting the risk adjustment parameter during the training, according to some other embodiments of the present disclosure.

FIG. 4 illustrates dynamically adjusting the risk adjustment parameter of the distortion function over time based on training progress of the agent, according to some embodiments of the present disclosure.

FIG. 5 illustrates a predefined mapping between task complexity levels and acceptable levels of risk, according to some embodiments of the present disclosure.

FIG. 6 illustrates dynamic adjustment of the risk adjustment parameter according to different stages of the task, according to some embodiments of the present disclosure.

FIG. 7 illustrates a plurality of subtasks of a manipulation stage of the task, according to some embodiments of the present disclosure.

FIG. 8A illustrates a control system for controlling a robot to execute the task in the dynamic environment, according to some embodiments of the present disclosure.

FIG. 8B illustrates functions executed by the control system for controlling the robot to execute the task, according to some embodiments of the present disclosure.

FIG. 9 is a schematic illustrating by non-limiting example a computing apparatus for implementing the methods and the systems of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

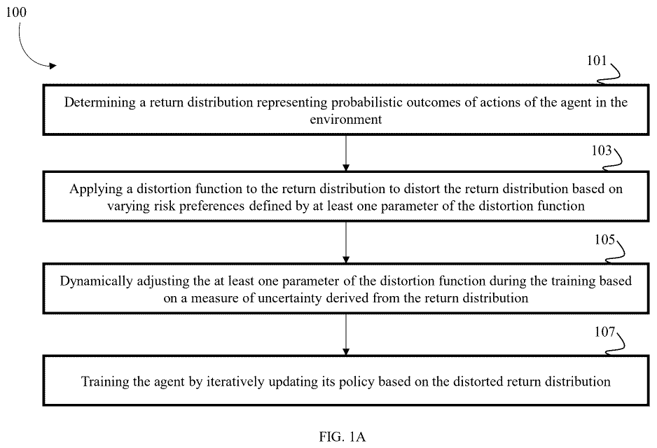

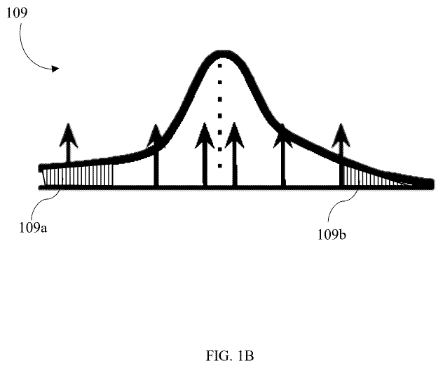

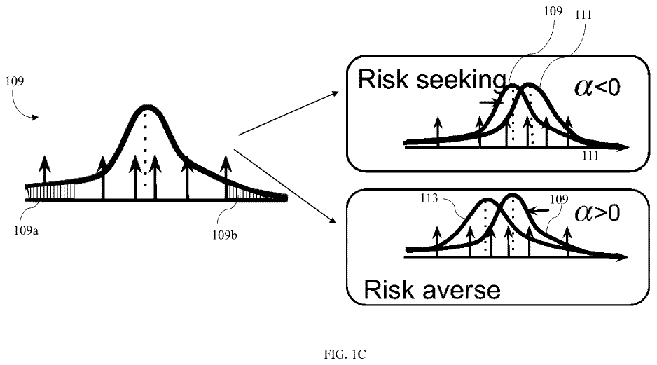

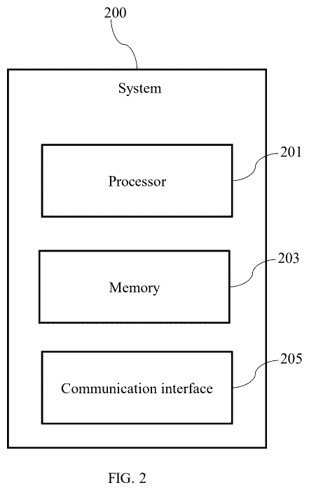

FIG. 1A illustrates a block diagram of a method for training an agent to perform a task in a dynamic environment, according to an embodiment of the present disclosure. In some embodiments, the agent is a robot configured to perform a task. The robot may be a mobile robot or a robotic manipulator. The robot is desired to perform the task in the dynamic environment. The dynamic environment corresponds to a space of a warehouse, a space of a factory setup, or any space/terrain where the robot is desired to perform the task. For example, the robot is a manipulator robot and the task of the robot includes one or a combination of pushing an object to a target location, stacking of objects, and aligning of the objects. In another example, the robot is the mobile robot and the task of the mobile robot is to lift and move the objects from one location to another location within an industrial or manufacturing unit, for transporting the objects.

It is an objective of some embodiments train the agent to perform the task. Some embodiments are based on the recognition that reinforcement learning (RL) can be used to train the agent to perform the task. The RL is a machine learning methodology where the agent learns to make decisions by interacting with the dynamic environment. Through iterative exploration and feedback, the agent refines its actions to optimize a cumulative reward. In each iteration, the agent updates its policy based on a reward obtained in that iteration. The policy is a strategy or function that the agent uses to decide what action to take in a given state.

The RL aims to maximize an expected return, which represents an average reward over all possible actions. However, such RL approach is well-suited to structured environments but may encounter limitations in the dynamic environment where variability and uncertainty are significant factors.

To overcome such limitations, some embodiments of the present disclosure use distributional RL, which models the cumulative reward as a probabilistic distribution, to train the agent. To this end, at step 101, the method 100 includes determining a return distribution representing probabilistic outcomes of actions of the agent in the dynamic environment, wherein the return distribution captures variability in the cumulative rewards of the training.

FIG. 1B illustrates an example return distribution 109, according to an embodiment of the present disclosure. The return distribution 109 represents a probabilistic distribution of the cumulative reward, known as ‘return’, which the agent can achieve from a given state when following the policy. The return Gₜ is the cumulative reward received by the agent starting at time t:

$${G}_{t} = {R}_{t + 1} + γ {R}_{t + 2} + {γ}^{2} {R}_{t + 3} + … = {\sum }_{k = 0}^{∞} {γ}^{k} {R}_{t + k + 1}$$

where: Rₜ₊ₖ₊₁: a reward received at time step t+k+1; and γ ∈ [0,1):

In the distributional RL, instead of modeling only the expected return, the return distribution Z^{π}(s) 109 is determined:

$${Z}^{π} ( s ) = P ( {G}_{t} \vert {S}_{t} = s )$$

The return distribution 109 captures a full range of possible cumulative rewards, along with their probabilities. The return distribution 109 has several characteristics that make it a powerful tool for the RL. Examples of the characteristics include a mean, a variance, and tails. The mean of the return distribution 109 corresponds to the expected return. The mean provides a baseline measure of the agent's performance but does not account for variability or extremes. The variance of the return distribution 109 measures a spread of possible outcomes, indicating a level of uncertainty or risk associated with a particular state or action. High variance indicates a wide range of possible outcomes, while low variance indicates more predictable outcomes. The tails of the return distribution 109 represent extreme outcomes. For example, a lower tail 109a captures the worst-case scenarios, which are critical for risk-averse policies, while an upper 109b tail reflects the best-case scenarios, which are focus of risk-seeking policies.

Further, an overall shape of the return distribution 109 conveys additional insights into likelihood and clustering of outcomes. For instance, a skewed distribution may indicate a higher probability of either very positive or very negative outcomes, while a multimodal distribution may indicate presence of multiple distinct behavioral patterns or scenarios.

Some embodiments are based on recognizing that by leveraging these characteristics, the return distribution 109 offers a nuanced understanding of the dynamic environment, equipping the agent to make informed and adaptive actions. Further, an advantage of determining the return distribution 109 is its ability to capture variability. The dynamic environment exhibits stochastic dynamics, where the same action can lead to different outcomes depending on variations in the agent or external conditions. By accounting for a full spectrum of outcomes, the return distribution 109 provides a detailed picture of these variations, enabling the agent to make decisions that are better aligned with the dynamic environment.

Referring back to FIG. 1A, at step 103, the method 100 includes applying a distortion function to the return distribution 109 to distort the return distribution 109 based on varying risk preferences defined by at least one parameter of the distortion function. The distortion function is a mathematical function applied to the return distribution 109 to emphasize specific regions of interest. In particular, the distortion function is configured to emphasize different regions of the return distribution 109 by adjusting weights of the different regions based on the at least one parameter of the distortion function. The distortion function reshapes or “distorts” the return distribution 109 to reflect desired risk preferences, enabling the policy to prioritize either risk-averse or risk-seeking behavior.

An example of the distortion function is Wang's metric, defined as:

$${g}_{Wang} ( τ ) = Φ ( {Φ}^{- 1} ( τ ) + α )$$

where:
Φ: a cumulative distribution function (CDF) of a standard normal distribution.
Φ⁻¹: inverse of the CDF (quantile function).
τ: quantile of the return distribution.
α: a risk adjustment parameter.

The risk adjustment parameter α of the distortion function corresponds to the at least one parameter of the distortion function that defines the risk preference. For instance, the risk adjustment parameter α>0 emphasizes the lower tail 109a of the return distribution 109, indicating a risk-averse policy is preferred. Likewise, the risk adjustment parameter α<0 emphasizes the upper tail 109b of the return distribution 109, indicating the risk-seeking policy is preferred. α=0 indicates a risk-neutral policy is preferred.

Some embodiments are based on the recognition that, in the dynamic environment, the risk preference may need to change dynamically as conditions evolve. For example, during training, the agent might start with a conservative (risk-averse) policy to ensure stability and gradually shift to a more exploratory (risk-seeking) policy as it gains confidence in well-understood states. Some embodiments are based on the realization that the risk preference can be dynamically adjusted by adjusting the risk adjustment parameter based on the uncertainty of the dynamic environment.

To this end, at step 105, the method 100 includes dynamically adjusting the risk adjustment parameter α during the training based on a measure of the uncertainty of the dynamic environment. In an embodiment, the measure of the uncertainty of the dynamic environment is quantified using a coefficient of variation (CV) of the return distribution 109:

$$CV = \frac{σ}{μ}$$

where:
σ: standard deviation of the return distribution.
μ: the mean of the return distribution.

The risk-adjustment parameter αₜ at training step t is updated using:

$${α}_{t} = ( {α}_{0} - {α}_{T} ) {e}^{- t / T} {CV}_{t} + {α}_{T}$$

where:
α₀: initial risk level (e.g., conservative).
α_{T}: final risk level (e.g., more optimistic).
T: a total number of training steps.
CVₜ: an average coefficient of variation at training step t.

If the risk adjustment parameter is adjusted to be greater than zero (α>0), the distortion function emphasizes the worst-case scenarios by assigning more weight to the lower tail 109a of the return distribution 109. If the risk adjustment parameter is adjusted to be less than zero (α<0), the distortion function prioritizes higher returns by weighting the upper tail 109b of the distribution 109. If the risk adjustment parameter is adjusted to be zero (α=0), the distortion function does not adjust the return distribution 109 and optimizes the expected return without additional weighting of the extreme outcomes. This dynamic adaptation of the risk adjustment parameter reduces likelihood of inefficiencies or failures in the training of the agent, thereby enhancing reliability and practicality of the training of the agent.

At step 109, the method 100 includes training the agent by iteratively updating its policy based on the distorted return distribution. For example, referring to FIG. 1C, the agent is trained with a return distribution 111 distorted with the distortion function having the risk adjustment parameter adjusted to be greater than zero (α>0). In another embodiment, the agent is trained with a return distribution 113 distorted with the distortion function having the risk adjustment parameter adjusted to be less than zero (α<0). In yet another embodiment, the agent is trained with the return distribution 109 with α=0.

In such a manner, the agent is trained with such a risk-adaptive distributional RL framework that adjusts risk preferences dynamically based on the uncertainty of the dynamic environment. The agent trained with the risk-adaptive distributional RL framework adapts between conservative and optimistic actions, ensuring robust performance even in uncertain, real-world conditions. By capturing variability, quantifying uncertainty, and dynamically adjusting the risk preferences, the agent is trained to handle complex and uncertain environments effectively. Further, by modeling the return distribution, the policy can adapt to prioritize actions that maximize safety (risk-averse) or pursue maximum rewards (risk-seeking), depending on the selected risk preference.

FIG. 2 shows a system 200 used for training the agent to perform the task, according to some embodiments of the present disclosure. The system 200 includes a processor 201, a memory 203, and a communication interface 205. The processor 201 may be a single core processor, a multi-core processor, a computing cluster, or any number of other configurations. The memory 203 may include random access memory (RAM), read only memory (ROM), flash memory, or any other suitable memory systems. Additionally, in some embodiments, the memory 203 may be implemented using a hard drive, an optical drive, a thumb drive, an array of drives, or any combinations thereof. The memory 203 having instructions stored thereon that, when executed by the processor 201, cause the processor 201 to execute the steps 101-107 described above in FIG. 1A and other steps executed for training the agent to perform the task.

The communication interface 205 may be any means such as a device or circuitry embodied in either hardware or a combination of hardware and software that is configured to receive and/or transmit data from/to other electronic devices in communication with the system 100. In this regard, the communication interface 205 may include, for example, an antenna (or multiple antennas) and supporting hardware and/or software for enabling communications with a plurality of different types of networks, such as first and second types of networks. Additionally or alternatively, the communication interface 205 may include the circuitry for interacting with the antenna(s) to cause transmission of signals via the antenna(s) or to handle receipt of signals received via the antenna(s).

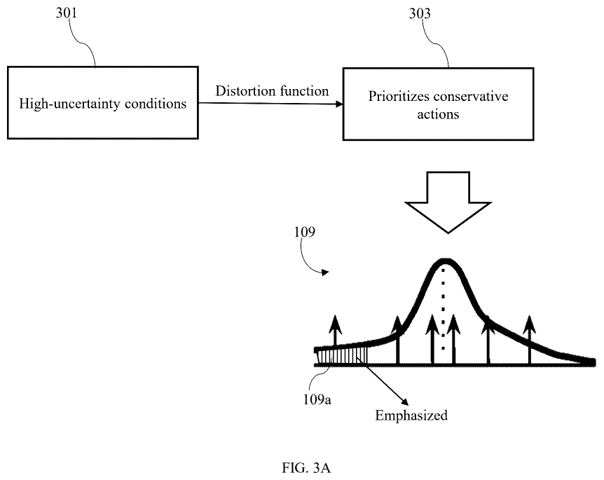

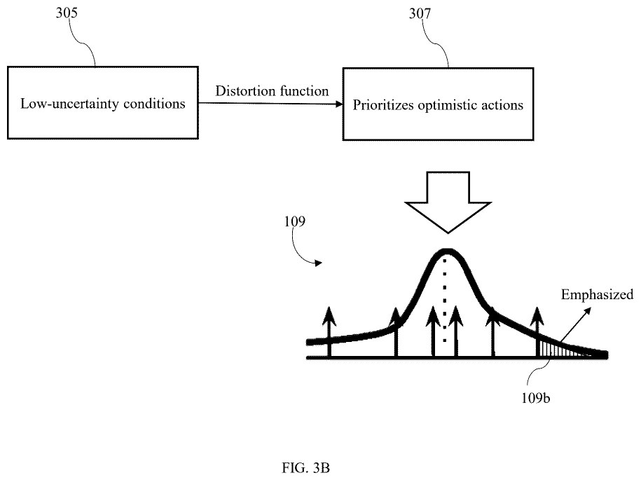

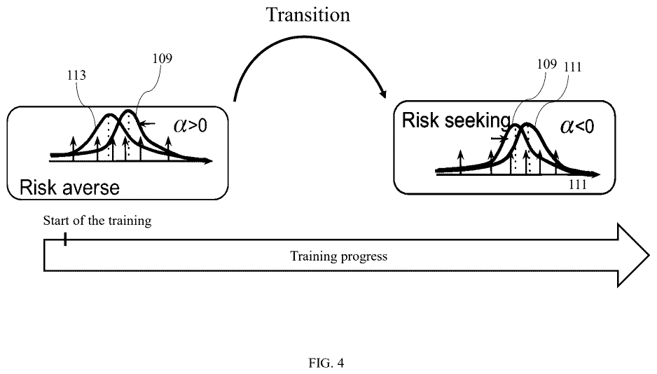

FIG. 3A illustrates dynamically adjusting the risk adjustment parameter during the training, according to some embodiments of the present disclosure. The risk adjustment parameter of the distortion function is adjusted during the training based on the measure of uncertainty, such that in high-uncertainty conditions 301 of the dynamic environment, the distortion function prioritizes conservative actions 303 by emphasizing lower-return outcomes, i.e., emphasizing the lower tail 109a of the return distribution 109. Further, as shown in FIG. 3B, in low-uncertainty conditions 305 of the dynamic environment, the distortion function prioritizes optimistic actions of the agent by emphasizing higher-return outcomes, i.e., emphasizing the upper tail 109b of the return distribution 109.

Alternatively, in some embodiments, the risk adjustment parameter of the distortion function is dynamically adjusted over time based on training progress of the agent.

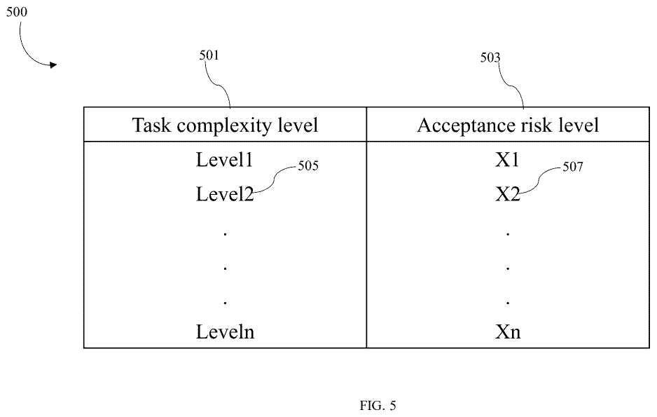

FIG. 4 illustrates dynamically adjusting the risk adjustment parameter of the distortion function over time based on the training progress of the agent, according to some embodiments of the present disclosure. For example, during training, the agent might start with a conservative (risk-averse) policy to ensure stability and gradually transitioned to a more exploratory (risk-seeking) policy as the agent gains confidence in well-understood states. In other words, at the start of training of the agent, the risk adjustment parameter is adjusted to be greater than zero (α>0) and the agent is trained with the return distribution 111 distorted with the distortion function having the risk adjustment parameter adjusted to be greater than zero (α>0). As the training progresses, the risk adjustment parameter is adjusted to be less than zero (α<0) and the agent is trained with the return distribution 113 distorted with the distortion function having the risk adjustment parameter adjusted to be less than zero (α<0).

In some other embodiments, the risk adjustment parameter of the distortion function is dynamically adjusted based on a predefined mapping between task complexity levels and acceptable levels of risk.

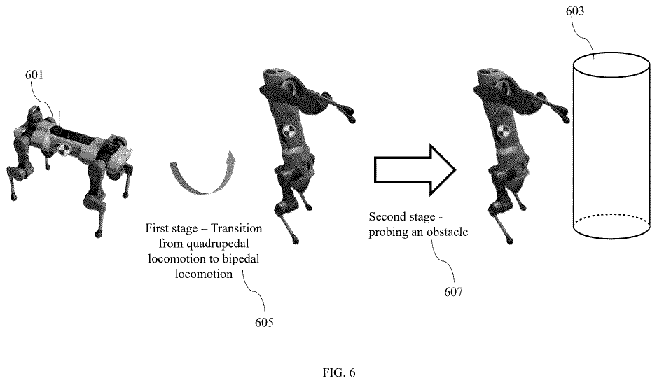

FIG. 5 illustrates a predefined mapping 500 between the task complexity levels and the acceptable levels of risk, according to some embodiments of the present disclosure. The predefined mapping 500 provides a mapping between different task complexity levels 501 level1, level2, . . . , leveln and corresponding acceptable risk levels 503 X1, X2, . . . , Xn, respectively. The predefined mapping 500 may be stored in the memory 203 or obtained from an external device via the communication interface 205. The predefined mapping 500 is used to dynamically adjust the risk adjustment parameter of the distortion function.

For example, if the task complexity level of the task of the agent is X2 505, then the risk adjustment parameter of the distortion function is adjusted to be less than or equal to acceptable risk level X2 507. In such a manner, the risk adjustment parameter of the distortion function is dynamically adjusted based on the predefined mapping 500 between the task complexity levels and the acceptable levels of risk.

Some embodiments are based on the realization that the task of the agent includes different stages and, for each stage of the task, the risk adjustment parameter of the distortion function can be adjusted according to a stability requirement of that stage of the task.

FIG. 6 illustrates dynamic adjustment of the risk adjustment parameter according to different stages of the task, according to some embodiments of the present disclosure. For example, the agent is a quadrupedal robot 601. The quadrupedal robot 601 is a type of robot designed to move using four legs, mimicking locomotion of four-legged animals like dogs, cats, or horses. These robots are engineered to navigate through environments in a way that resembles the agility and stability of these animals.

A task of the quadrupedal robot 601 is to probe an obstacle 603. The task of probing the obstacle 603 includes a first stage 605 involving transitioning from quadrupedal locomotion to bipedal locomotion. The quadrupedal locomotion refers to a movement of the robot 601 using its four legs. The bipedal locomotion in the context of a quadrupedal robot refers to a movement of the robot 601 using its two legs. Transitioning from the quadrupedal locomotion to the bipedal locomotion refers to switching from using four legs to two legs for the movement.

Further, the task of probing the obstacle 603 includes a second stage 607 involving probing the obstacle 603. During the first stage 605, i.e., during the transition from the quadrupedal locomotion to the bipedal locomotion, a conservative approach is beneficial at the outset to establish stability of the robot 601, followed by a gradual shift to more exploratory or risk-seeking actions as the robot 601 gains balance and confidence. Therefore, during training/learning of the first stage 605 of the task, the risk adjustment parameter is adjusted to be α>0 (risk-averse). Further, during training/learning of the second stage 607 of the task, the risk adjustment parameter is adjusted to be α<0 (risk-seeking). Similarly, the risk preferences can be tailored to differentiate between precision tasks, such as obstacle avoiding, and broader activities, such as payload transport.

By allowing to adjust the risk adjustment parameter in real time, the risk-adaptive distributional RL framework offers greater adaptability and robustness, making it well-suited to scenarios with varying levels of difficulty or uncertainty. The conceptualization of the risk adjustment as an active decision variable, rather than merely an outcome to be managed, adds further depth to RL. By incorporating the risk adjustment directly into the training process, the risk-adaptive distributional RL framework enables precise control over a balance between safety/stability and performance of the agent. This approach facilitates robust and efficient behavior across a wide range of operating conditions.

In addition to the different stages within the task, subtasks of the stage of the task can also benefit from tailored risk preferences. For example, the quadrupedal robot 601 stabilizing its gait may prioritize safety, whereas a subsequent subtask, such as manipulating an object, might involve a more risk-tolerant policy. This level of granularity in risk adaptation offers both flexibility and precision, improving the overall functionality of the robot. As a result, a problem of balancing locomotion and manipulation of the robot 601 is solved by some embodiments by enabling dynamic bipedalism, providing the robot 601 with flexibility and stability.

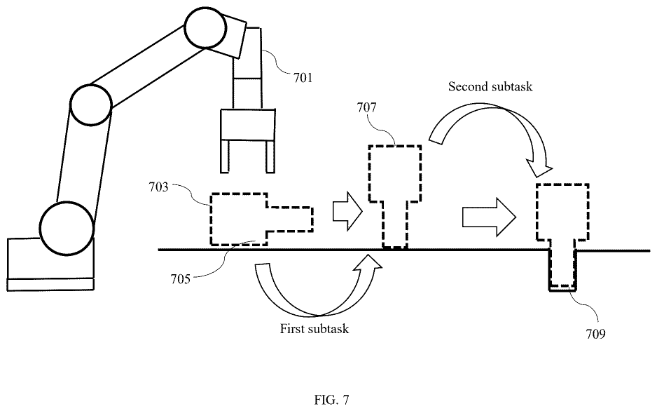

FIG. 7 illustrates a plurality of subtasks of a manipulation stage of the task of the quadrupedal robot 601, according to some embodiments of the present disclosure. For each subtask of the plurality of subtasks, the risk adjustment parameter is adjusted according to at least one of a stability and a recision requirement of the corresponding subtask. For instance, a robotic arm 701 of the quadrupedal robot 601 is desired to manipulate an object, such as a peg 703. The manipulation task includes a first subtask of reorienting the peg 703 in an initial pose 705 to a pose 707, and a second subtask that includes inserting the reoriented peg into to a hole 709.

The second subtask is an intricate task requiring precision and stability of the robotic arm 701. Further, any risky actions by the robotic arm 701 while performing the second subtask may damage the peg 703. To this end, the robotic arm 701 shall prefer lesser risk and prioritize minimizing the likelihood of negative outcomes. Therefore, for training/learning of the second subtask, the risk adjustment parameter is adjusted to be α>0 (risk-averse). On other hand, for training/learning of the first subtask, the risk adjustment parameter is adjusted to be α<0 (risk-seeking).

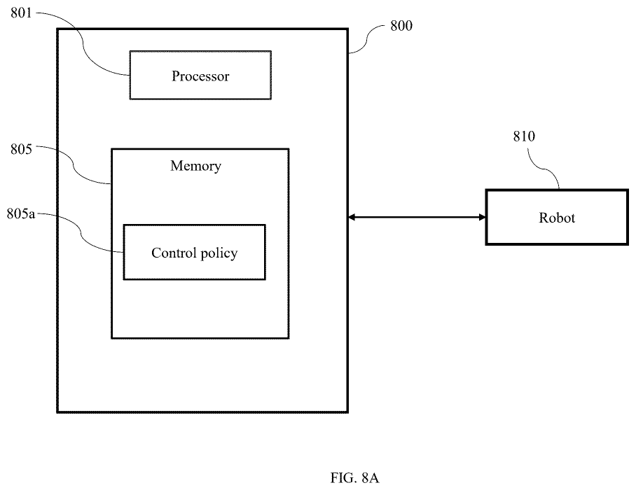

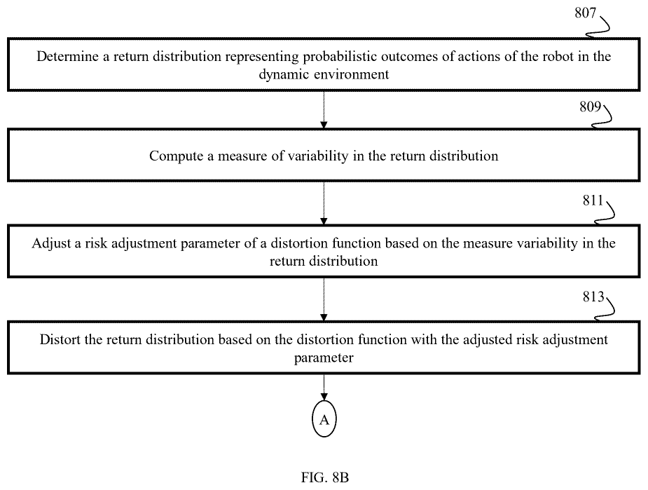

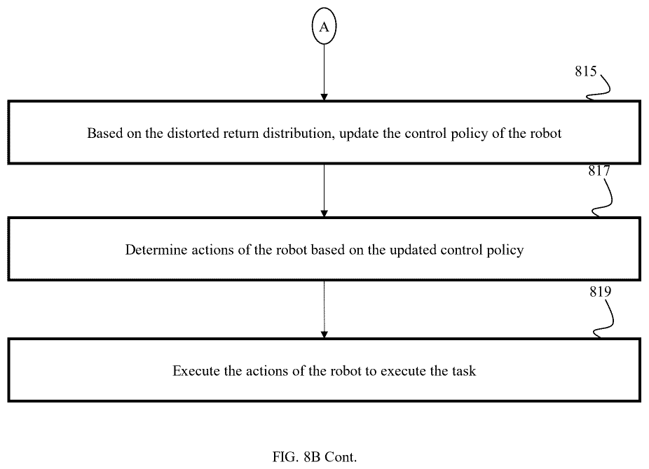

Additionally, such dynamic adjustments of the risk adjustment parameter to adjust the risk preference can be performed during execution of the task by the trained agent. Therefore, the risk adaptation can be performed during both the training and execution of the task in real time, providing the agent with flexibility and stability, which in turn improve overall functionality of the agent. In other words, the risk-adaptive distributional RL framework used for training the agent to perform the task can also be used during the execution of the task by the agent. The present disclosure provides a control system that uses the risk-adaptive distributional RL framework during the execution of the task. Such a control system is explained below in FIG. 8.

FIG. 8A illustrates a control system 800 for controlling a robot 810 to execute the task in the dynamic environment, according to some embodiments of the present disclosure. The control system 800 is communicatively coupled to a robot 810. In some embodiments, the control system 800 is integrated into the robot 810. The robot 810 may be the quadrupedal robot 601 or any mobile robot. The control system 800 includes a processor 801 and a memory 803. The processor 801 may be a single core processor, a multi-core processor, a computing cluster, or any number of other configurations. The memory 803 may include random access memory (RAM), read only memory (ROM), flash memory, or any other suitable memory systems. Additionally, in some embodiments, the memory 803 may be implemented using a hard drive, an optical drive, a thumb drive, an array of drives, or any combinations thereof.

The memory 803 is configured to store a control policy 803a for controlling the robot 810 to execute the task. The control policy 803a is a strategy or function that the robot 810 uses to decide what action to take in a given state of the robot 810 to execute the task. The memory 203 having instructions stored thereon that, when executed by the processor 201, cause the processor 201 to execute functions described below in FIG. 8B.

FIG. 8B illustrates functions executed by the processor 801 for controlling the robot 810 to execute the task, according to some embodiments of the present disclosure. At block 807, the processor 801 is configured to determine a return distribution (e.g., the return distribution 109) representing probabilistic outcomes of actions of the robot 810 in the dynamic environment.

At block 809, the processor 801 is configured to compute a measure of variability in the return distribution. The measure of variability corresponds to a coefficient of variation of the return distribution. The coefficient of variation of the return distribution is computed based on a mean and a standard deviation of the return distribution. The measure of variability of the return distribution captures external conditions and uncertainty of the dynamic environment. The external conditions include one or more of irregularities of a terrain on which the robot 810 executes the task, external forces acting on the robot 810, and characteristic of a payload of the robot 810.

At block 811, the processor 801 is configured to adjust the risk adjustment parameter α of the distortion function based on the measure variability in the return distribution. At block 813, the processor 801 is configured to distort the return distribution based on the distortion function with the adjusted risk adjustment parameter. At block 815, based on the distorted return distribution (e.g., the return distribution 111 or the return distribution 113), the processor 801 is configured to update the control policy 808a of the robot 810.

At block 817, the processor 801 is configured to determine actions of the robot 810 based on the updated control policy. At block 819, the processor 801 is configured to execute the actions of the robot 810 to execute the task. To execute the actions of the robot 810, the processor 801 is configured to determine control commands to one or more actuators of the robot 810 based on the determined actions. Further, the processor 801 is configured to apply the control commands to the one or more actuators of the robot 810 to execute the task.

Such an execution of the task by adjusting the risk in real time, the robot 810 adapts between conservative and optimistic actions, ensuring robust performance even in uncertain, real-world conditions. By capturing variability, and dynamically adjusting the risk, the robot 810 can handle complex and the dynamic environments effectively.

Further, the risk-adaptive distributional RL framework described above in FIG. 1A is mathematically described below. For the purpose of explanation, the risk-adaptive distributional RL framework is explained in context of bipedalism in quadrupedal robots.

### 1. Preliminary

Bipedal locomotion learning is formulated as a Partially Observable Markov Decision Process (POMDP) defined by (S, [symbol] , [symbol] , R, Ω, O, γ), where S represents a state space, [symbol] an action space, [symbol] :S× [symbol] S is a transition function, R:S× [symbol] is a reward function, Ω is a set of observations, O is an observation function, γ is a discount factor. The objective is to train a policy π* which maximizes a discounted cumulative reward:

$${π}^{*} = arg {max}_{π} {𝔼}_{{s}_{o} ∼ {ρ}_{o} , {a}_{t} ∼ π ( \cdot \vert {s}_{t} )} [ {\sum }_{t \geq 0} {γ}^{t} r ( {s}_{t} , {a}_{t} ) ] .$$

The distributional RL learns value distribution, instead of the expected return as a value function. With policy π, the return is a random variable Z^{π} that represents the cumulated discounted rewards along one trajectory,

$${Z}^{π} = {\sum }_{t = 0}^{∞} {γ}^{t} {R}_{t} .$$

The value function for many standard RL algorithms is, V^{π}(x)= [symbol] [Z^{π}(x)] while distributional RL explicitly parameterizes the return distribution with quantile functions or discrete distribution. In some embodiments, the return distribution is approximated by estimating quantiles τ₁, . . . , τ_{N}, τᵢ=i/N, i=1, . . . , N, with a parametric model θ,

$${Z}_{θ} ( x ) := \frac{1}{N} {\sum }_{i = 1}^{N} {δ}_{{θ}_{i} ( x )} , \qquad ( 1 )$$

where θᵢ(x) is i^{th} quantile of the return distribution Z^{π}(x), and δ_{θ}_{ᵢ}₍ₓ₎ denotes a Dirac function at θᵢ(x).
2.1 Control Policy with RL

Observation and Action Space—The bipedal locomotion policy receives observations which include proprioceptive information, locomotion command, and the last action aₜ₋₁ ∈ [symbol] . The Proprioceptive information includes joint position θₜ ∈ [symbol] and joint velocity at \dot{θ}∈ [symbol] provided by joint encoders and projected gravity in a robot frame gₜ ∈ [symbol] . Command

$${c}_{t} = [ {v}_{x}^{c} , {v}_{y}^{c} , {ω}_{yaw}^{c} , {z}^{c} , {f}^{c} ]$$

includes a velocity command specifying linear velocities in longitudinal and lateral directions, angular velocity around a vertical axis, base height, and stepping frequency. Privileged observation for a critic network at the training stage includes extra information only available in simulation such as joint friction and restitution coefficient. In an embodiment, dimension of the action space [symbol] is 12, which equals a number of actuators. Predictions of the policy, Δθₜ ∈ [symbol] , are joint angles relative to a nominal quadrupedal standing position.

Reward functions—Reward functions include task-specific rewards for the bipedal locomotion and auxiliary rewards adapted to optimize foot contact, action smoothness, energy consumption, joint position, etc. The task-specific reward functions are listed in Table 1 below. In addition to Base Height which encourages maintaining base height z^{c} and Base Pitch to promote an upright position, some embodiments use Upright Balance to penalize velocity along z-axis and changes in pitch angle \dot{p} when the robot is upright. Velocity tracking rewards include Linear Tracking and Angular Tracking, where σ and σ_{yaw} are scaling factors.

Apart from direct tracking reward, some embodiments design a Support Polygon reward to track a relative position between a base center of mass (CoM) and a support polygon. When the CoM moves ahead of the support polygon, the robot accelerates. Conversely, when the CoM lags behind, the robot decelerates. This mechanism enables continuous balance control while tracking a desired velocity. The relative position between robot CoM and the support polygon is characterized by arctan(Δx_{b}/Δz_{b}). Δx_{b} and Δz_{b} are relative positions of rear feet in body frame along x-axis and z-axis. arctan(Δx_{b}/Δz_{b}) is expected to be positive when the robot needs to accelerate and negative when decelerating. This angle is essentially different than pitch angle and only degenerates to the pitch angle when the parametric model is simplified to a single inverted pendulum.

TABLE 1
Task reward functions

| | |
|---|---|
| Base Height | −(z − z^{c})² |
| Base Pitch | −cos(p^{c} − p) |
| Upright Balance | $exp ( - \frac{{v}_{z}^{2}}{σ} ) + exp ( - {\dot{p}}^{2} {σ}_{yaw} ) if is upright , else 0$ |
| Linear Tracking | $exp ( - \vert {v}_{xy} - \frac{{v}_{xy}^{c} {\vert}^{2}}{σ} ) if is upright , else 0$ |
| Angular Tracking | $exp ( - {\vert {w}_{yaw} - {w}_{yaw}^{c} \vert}^{2} {σ}_{yaw} ) if is upright , else 0$ |
| Support Polygon | $- {\vert {v}_{x}^{c} \vert}^{2} {( \frac{π}{2} - \vert arctan ( \frac{Δ {x}_{b}}{Δ {z}_{b}} \vert )}^{2} if arctan ( \frac{Δ {x}_{b}}{Δ {z}_{b}} ) {v}_{x}^{c} < 0$ |

### 2.2 Risk-Aware Distributional Proximal Policy Optimization (PPO)

In the distributional PPO, an actor network remains the same as in standard PPO and is trained to optimize a clipped objective,

$$ℒ ( ϕ ) = {𝔼}_{t} [ min ( {η}_{t} ( ϕ ) {\hat{A}}_{t} , clip ( {η}_{t} ( ϕ ) , 1 - ϵ , 1 + ϵ ) {\hat{A}}_{t} ) ] \qquad ( 2 )$$

where

$${η}_{t} ( ϕ ) = \frac{{π}_{ϕ} ( {a}_{t} \vert {o}_{t} )}{{π}_{{ϕ}_{old}} ( {a}_{t} \vert {o}_{t} t )} ,$$

is a probability ratio between new policy π_{φ}, and old policy π_{φ}_{_{old}}, Âₜ is an estimated advantage computed using Generalizable Advantage Estimation (GAE). The critic network differs from the standard PPO by predicting quantiles of the value distribution as in Equation (1), instead of just the expected value.

$${θ}_{i} ( x ) = {F}_{Z}^{- 1} ( {τ}_{i} )$$

for τᵢ=1/N, i=1, . . . , N are N− quantiles of the return distribution Z^{π}(x), and

$${F}_{Z}^{- 1}$$

denotes an inverse CDF of the return distribution Z^{π}(x). For the critic network that approximate the return distribution by predicting θ₁(x), . . . , θ_{N}(x), the objective is to minimize the following quantile loss, which effectively minimizes 1-Wasserstein distance between an empirical distribution \hat{Z}^{π}(x) and a parameterized quantile distribution

$${Z}_{θ}^{π} ( x ) :$$

$$ℒ ( θ ) = {𝔼}_{t} [ \frac{1}{N} {\sum }_{i = 1}^{N} ( τ - {1}_{{z}_{t} - {θ}_{t}^{i} < 0} ) ( {z}_{t} - {θ}_{t}^{i} ) ] \qquad ( 3 )$$

where

$${z}_{i} \sim {Z}^{π} ( {x}_{t} ) , and {θ}_{t}^{i} = {θ}_{i} ( {x}_{t} ) .$$

The value function derived from the return distribution is used to estimate the advantage Âₜ for an actor-network update. Given the return distribution predicted by the critic network, a risk-neutral value function is calculated as,

$$V ( x ) = {\sum }_{i = 1}^{N} ( {τ}_{i} - {τ}_{i - 1} ) {θ}_{i} ( x ) = \frac{1}{N} {θ}_{i} ( x ) . \qquad ( 4 )$$

To learn a risk-aware policy, distortion risk measures ρ_{g}_{_{α}} associated with a distortion function ga is applied to the return distribution. Conditional Value at Risk (CVaR) is commonly applied to have risk-averse behaviors since only the lower tail is quantified. Some embodiments apply Wang's metric so that the risk preference can be adjusted from averse (α>0) to seeking (α<0) as in equation (5),

$${g}_{α}^{Wang} ( τ ) = Φ ( {Φ}^{- 1} ( τ ) + α ) . \qquad ( 5 )$$

Then a new value function is given by the distorted return distribution as in equation (6).

$${V}_{α} ( x ) = {ρ}_{{g}_{α}} ( {Z}_{θ}^{π} ( x ) ) = {\sum }_{i = 1}^{N} ( {g}_{α} ( {τ}_{i} ) - {g}_{α} ( {τ}_{i - 1} ) ) {θ}_{i} ( x ) \qquad ( 6 )$$

When α>0, calculation of the value function is conservative, by assigning more weight to worst-case left tails, while α<0 makes the calculation of the value function optimistic by assigning more weight to higher returns.

### 2.3 Uncertainty Modeling and Adaptive Risk Level

Transition in the POMDP is assumed to be deterministic. Aleatory uncertainty comes from partial observation of state and domain randomization, while epistemic uncertainty arises from lack of environment knowledge to make informed predictions. Optimism in the face of epistemic uncertainty encourages exploration, allowing for collection of more informative data to maximize long-term returns. However, conservativeness is essential to ensure worst-case performance when the aleatory uncertainty is present. The uncertainty of the environment is modeled as uncertainty of the parameterized distribution

$${Z}_{θ}^{π} ( x )$$

predicted by the critic network, represented by the Coefficient of Variation (CV),

$${CV}_{{Z}_{θ}^{π} ( x )} = \frac{\sqrt{Var ( {Z}_{θ}^{π} ( x ) )}}{{𝔼Z}_{θ}^{π} ( x )} = \frac{σ}{μ} . \qquad ( 7 )$$

This normalized measure allows for comparison of dispersion across different return distributions, even if the means of the return distributions are drastically different from each other. It is particularly advantageous over non-normalized measures as the mean of the return distribution tends to increase significantly during training due to increased rewards.

The parameter α of the distortion function

$${g}_{α}^{Wang} ( τ )$$

is formulated as a function of the modeled uncertainty

$${CV}_{{Z}_{θ}^{π} ( x )}$$

and training steps t,

$${α}_{t} = ( {α}_{0} - {α}_{T} ) {e}^{- \frac{t / T}{{CV}_{t}}} + {α}_{T} \qquad ( 8 )$$

where T is the total training steps and CVₜ is an average over batch of

$${CV}_{{Z}_{θ}^{π} ( x )}$$

at step t. With α₀− α_{T}>0, the policy begins conservatively and becomes increasingly optimistic as training progresses.

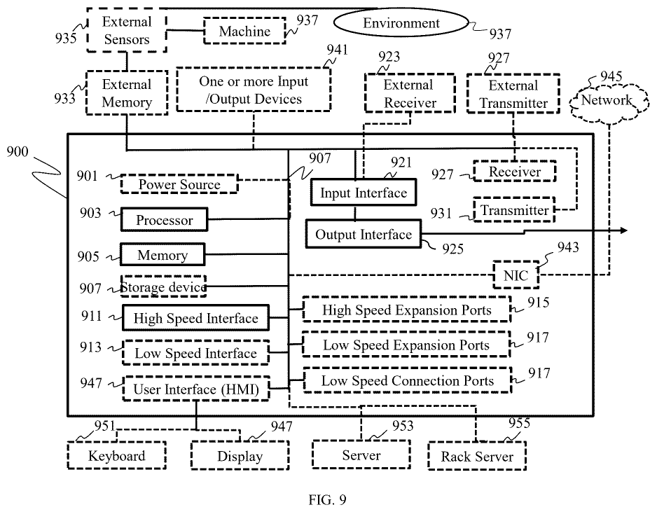

FIG. 9 is a schematic illustrating by non-limiting example a computing apparatus for implementing the methods and the systems of the present disclosure. The computing device 900 can include a power source 901, a processor 903, a memory 905, a storage device 907, all connected to a bus 909. Further, a high-speed interface 911, a low-speed interface 913, high-speed expansion ports 915 and low speed connection ports 917, can be connected to the bus 909. In addition, a low-speed expansion port 919 is in connection with the bus 909. Further, an input interface 921 can be connected via the bus 909 to an external receiver 923 and an output interface 925. A receiver 927 can be connected to an external transmitter 929 and a transmitter 931 via the bus 909. Also connected to the bus 909 can be an external memory 933, external sensors 935, machine(s) 937, and an environment 939. Further, one or more external input/output devices 941 can be connected to the bus 909. A network interface controller (NIC) 943 can be adapted to connect through the bus 909 to a network 945, wherein data or other data, among other things, can be rendered on a third-party display device, third party imaging device, and/or third-party printing device outside of the computer device 900.

The memory 905 can store instructions that are executable by the computer device 900, historical data, and any data that can be utilized by the methods and systems of the present disclosure. The memory 905 can include random access memory (RAM), read only memory (ROM), flash memory, or any other suitable memory systems. The memory 905 can be a volatile memory unit or units, and/or a non-volatile memory unit or units. The memory 905 may also be another form of computer-readable medium, such as a magnetic or optical disk.

The storage device 907 can be adapted to store supplementary data and/or software modules used by the computer device 900. For example, the storage device 907 can store historical data and other related data as mentioned above regarding the present disclosure. Additionally, or alternatively, the storage device 907 can store historical data like data as mentioned above regarding the present disclosure. The storage device 907 can include a hard drive, an optical drive, a thumb-drive, an array of drives, or any combinations thereof. Further, the storage device 907 can contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, the processor 903), perform one or more methods, such as those described above.

The computing device 900 can be linked through the bus 909, optionally, to a display interface or user Interface (HMI) 947 adapted to connect the computing device 900 to a display device 949 and a keyboard 951, wherein the display device 949 can include a computer monitor, camera, television, projector, or mobile device, among others. In some implementations, the computer device 900 may include a printer interface to connect to a printing device, wherein the printing device can include a liquid inkjet printer, solid ink printer, large-scale commercial printer, thermal printer, UV printer, or dye-sublimation printer, among others.

The high-speed interface 911 manages bandwidth-intensive operations for the computing device 900, while the low-speed interface 913 manages lower bandwidth-intensive operations. Such allocation of functions is an example only. In some implementations, the high-speed interface 911 can be coupled to the memory 905, the user interface (HMI) 947, and to the keyboard 951 and the display 949 (e.g., through a graphics processor or accelerator), and to the high-speed expansion ports 915, which may accept various expansion cards via the bus 909. In an implementation, the low-speed interface 913 is coupled to the storage device 907 and the low-speed expansion ports 917, via the bus 909. The low-speed expansion ports 917, which may include various communication ports (e.g., USB, Bluetooth, Ethernet, wireless Ethernet) may be coupled to the one or more input/output devices 941. The computing device 900 may be connected to a server 953 and a rack server 955. The computing device 900 may be implemented in several different forms. For example, the computing device 900 may be implemented as part of the rack server 955.

The description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Further, embodiments of the present disclosure and the functional operations described in this specification can be implemented in digital electronic circuitry, in tangibly-embodied computer software or firmware, in computer hardware, including the structures disclosed in this specification and their structural equivalents, or in combinations of one or more of them. Further some embodiments of the present disclosure can be implemented as one or more computer programs, i.e., one or more modules of computer program instructions encoded on a tangible non transitory program carrier for execution by, or to control the operation of, data processing apparatus. Further still, program instructions can be encoded on an artificially generated propagated signal, e.g., a machine-generated electrical, optical, or electromagnetic signal, which is generated to encode information for transmission to suitable receiver apparatus for execution by a data processing apparatus. The computer storage medium can be a machine-readable storage device, a machine-readable storage substrate, a random or serial access memory device, or a combination of one or more of them.

According to embodiments of the present disclosure the term “data processing apparatus” can encompass all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code.

A computer program can be deployed to be executed on one computer or on multiple computers that are located at one site or distributed across multiple sites and interconnected by a communication network. Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

We claim:

1. A method for training an agent to perform a task in a dynamic environment, wherein the method uses a processor coupled with stored instructions implementing the method, wherein the instructions, when executed by the processor carry out steps of the method, comprising:
determining a return distribution representing probabilistic outcomes of actions of the agent in the dynamic environment, wherein the return distribution captures variability in cumulative rewards of the training;
applying a distortion function to the return distribution to distort the return distribution based on varying risk preferences defined by at least one parameter of the distortion function;
dynamically adjusting the at least one parameter of the distortion function during the training based on a measure of uncertainty derived from the return distribution; and
training the agent by iteratively updating its policy based on the distorted return distribution.

2. The method of claim 1, wherein the distortion function is configured to adjust weights of different regions of the return distribution based on the at least one parameter of the distortion function.

3. The method of claim 1, wherein the distortion function includes Wang metric.

4. The method of claim 1, wherein the measure of uncertainty is a coefficient of variation of the return distribution.

5. The method of claim 1, wherein the at least one parameter of the distortion function is adjusted during training based on the measure of uncertainty, such that:
in high-uncertainty conditions of the dynamic environment, the distortion function prioritizes conservative actions by emphasizing lower-return outcomes; and
in low-uncertainty conditions of the dynamic environment, the distortion function prioritizes optimistic actions by emphasizing higher-return outcomes.

6. The method of claim 1, further comprising:
dynamically adjusting the at least one parameter of the distortion function over time based on training progress of the agent.

7. The method of claim 1, wherein the dynamic adjustment the at least one parameter of the distortion function is based on a predefined mapping between task complexity levels and acceptable levels of risk.

8. The method of claim 1, wherein the task includes different stages, and wherein the at least one parameter of the distortion function is dynamically adjusted for each stage of the task according to a stability requirement of the corresponding stage of the task.

9. The method of claim 8, wherein the agent is a quadrupedal robot, and the different stages of the task includes a first stage and a second stage, the first stage includes transitioning from quadrupedal locomotion to bipedal locomotion of the quadrupedal robot and the second stage includes probing an obstacle.

10. The method of claim 8, wherein each stage of the different stages includes a plurality of subtasks, and wherein the at least one parameter of the distortion function is adjusted for each subtask of the plurality of subtasks according to at least one of a stability and a precision requirement of the corresponding subtask.

11. A system for training an agent to perform a task in a dynamic environment, comprising: a processor; and a memory having instructions stored thereon that, when executed by the processor, cause the system to:
determine a return distribution representing probabilistic outcomes of actions of the agent in the dynamic environment, wherein the return distribution captures variability in cumulative rewards of the training;
apply a distortion function to the return distribution to distort the return distribution based on varying risk preferences defined by at least one parameter of the distortion function;
dynamically adjust the at least one parameter of the distortion function during the training based on a measure of uncertainty derived from the return distribution; and
train the agent by iteratively updating its policy based on the distorted return distribution.

12. The system of claim 11, wherein the distortion function is configured to adjust weights of different regions of the return distribution based on the at least one parameter of the distortion function.

13. The system of claim 11, wherein the distortion function includes Wang metric.

14. The system of claim 11, wherein the measure of uncertainty is a coefficient of variation of the return distribution.

15. The system of claim 11, wherein the processor is configured to adjust at least one parameter of the distortion function during training based on the measure of uncertainty, such that:
in high-uncertainty conditions of the dynamic environment, the distortion function prioritizes conservative actions by emphasizing lower-return outcomes; and
in low-uncertainty conditions of the dynamic environment, the distortion function prioritizes optimistic actions by emphasizing higher-return outcomes.

16. The system of claim 11, wherein the processor is further configured to dynamically adjust the at least one parameter of the distortion function over time based on training progress of the agent.

17. The system of claim 11, wherein the processor is further configured to dynamically adjust the at least one parameter of the distortion function based on a predefined mapping between task complexity levels and acceptable levels of risk.

18. A control system for controlling a robot to execute a task in a dynamic environment, comprising:
a memory configured to store a control policy of the robot for controlling the robot to execute the task; and
a processor communicatively coupled to the memory and configured to:
determine a return distribution representing probabilistic outcomes of actions of the robot in the dynamic environment;
compute a measure of variability in the return distribution;
adjust a risk adjustment parameter of a distortion function based on the measure variability in the return distribution;
distort the return distribution based on the distortion function with the adjusted risk adjustment parameter;
based on the distorted return distribution, update the control policy of the robot; and
execute at least action of the robot based on the updated control policy, to execute the task in the dynamic environment.

19. The control system of claim 18, wherein the measure of variability captures external conditions, including terrain irregularities, external forces, or payload characteristics.

20. The control system of claim 18, wherein the measure of variability corresponds to a coefficient of variation of the return distribution, and wherein the processor is further configured to compute the coefficient of variation of the return distribution based on a mean and a standard deviation of the return distribution.
